(19) United States
(12) Patent Application Publication
(10) Pub. No.: US 2001/0007984 A1
(43) Pub. Date: Jul. 12, 2001

(54) Client-server computing software architecture

(76) Inventors: Ahmed Fattah, St. Leonards (AU); Vijay Seetharaman, Lower Hutt (NZ); Andrew Richard Helm, Whale Beach (AU); David J. McCarty, Vence (FR); Nicholas Strong, Auckland (NZ)

Correspondence Address: Ronald L. Drumheller, Esq, 94 Teakettle Spout Road, Mahopac, NY, 10541, US

(21) Appl. No.: 09/737,014

(22) Filed: Dec. 14, 2000

(30) Foreign Application Priority Data
Dec. 14, 1999 (JP) 11-354496

(51) Int. Cl. G06F 7/00

(52) U.S. Cl. 707/1

(57) ABSTRACT

The invention relates to software architecture for client-server systems and the execution of service requests. On the client, the presentation (UI) layer 100 presents a user with a graphical user interface. The service request can be such as ‘Find Customer’, which seeks to extract a customer's details. The application (process) layer 102 deals with the specific ‘service requests’. The middleware (SRB) layer 104 deals with the framing and dispatching of service requests as bit streams. On the server, a similar, but not identical middleware (SRB) layer 106 receives bit streams and recreates service requests therefrom. The server SRB 106 communicates with the server application (process) layer 108 where the recreated service requests are executed. The application layer 108 has communication with a database 40 to persist or retrieve data stored therein relating to any service requests. In response to a service request on the client, the methodology involves firstly the instantiation of one or more Business Objects (BOs) on the client. The BO is populated with any needed attributes. A Service Object (SO) is instantiated on the client, and populating (i.e. associating) the SO with one or more BOs. The SO is called, and passed to the server as a binary stream. The SO and associated BO(s) are then reinstantiated on the server, whereafter the service is executed. The SO is then populated with the results of the executed service, and the resultant SO passed back to the client. The returned BO attributes are updated on the client.

### FIELD OF THE INVENTION

This invention relates to a method for performing a transaction between computer systems, particularly client-server transaction, and more particularly to the execution of service requests.

### BACKGROUND OF THE INVENTION

In modem large computing systems, a common topology has three tiers: (i) a presentation tier characterized by multiple client workstations focusing on user interactions, (ii) a business tier characterized by multiple servers executing application/business logic, and (iii) a data tier characterized by multiple databases working on data storage and organization. A Local or Wide Area Network (LAN/WAN) interconnects the three tier elements.

Such computing systems find application in many and varied fields, ranging from university research and teaching facilities to business applications. In fact, almost every business will utilise such a system to transact its functions and serve its clients. For example, a system may be used to control inventory, for word processing and accounts purposes, and for servicing client's enquiries. Many businesses have very large client bases and may provide an extensive inventory of goods and services. One illustrative example is a telecommunications service provider (Telco) that serves a countrywide client base. The Telco's subscribers thus can number in the millions, and each customer will expect a near immediate response from a Customer Service Representative (CSR) to any inquiry, which can range from billing information, a request for a new service, or the placing of orders for a product.

Similar examples are seen in Utilities, insurance companies, banks, hospitals, law firms, accountancy firms, stock exchanges, universities and Government agencies, to name but a few.

Any client-server system requires a software architecture. One such known architecture is the Common Object Request Broker Architecture (CORBA) Standard devised by the Object Management Group. A description of the CORBA Standard can be found at the OMG website: http://www.omg.org/corbra.

It is common for a software architecture to be implemented by object oriented programs. Objects exist only in an abstract world, making it necessary to give them a ‘reality’—in the sense of packets of bytes—when they are passed between distributed processes of a computing system. A client-server interaction can be between two machines (e.g. client machine and server machine, or server machine and database) or between two processes residing on the same machine. A concomitant of CORBA is the Interface Definition Language (IDL) that performs the translation of instances of objects to physical data packets, and vice versa.

In CORBA version 2.0, distributed objects (constituted by attribute and behaviour states) have locations that are unknown to the clients of those objects (i.e. other processes). The clients work with a proxy object (i.e. an imposter) that provides interface compatibility with the remote object. The remote object maintains the state information from which the proxy obtains its state information. In other words, the objects of one process contain a pointer to the relevant object of another process. It is only the pointer that is passed between processes. This is known as the ‘pass by reference’ paradigm.

CORBA version 3.0, on the other hand, contemplates objects ‘passed by value’. This means that the actual object is passed between processes. For computing systems implementing a Telco client service function (for example), a CORBA software architecture requires that for each proxy object existing on a client, the actual object must exist on the server for the lifetime of the proxy object Also, any single object can have hundreds of attributes and relationships with similar numbers of other objects, and these also will be passed across the network. These requirements can impose extreme demand on memory space and network bandwidth, which can degrade performance (e.g. response time) of the system application(s).

It is an object of the invention to avoid, or at least ameliorate the foregoing problems. It is a further preferred object to provide a client-sever transaction that is highly scalable in a distributed object-oriented application.

### SUMMARY OF THE INVENTION

In a first aspect the invention provides a method for performing a client-server transaction, comprising the steps of:

(a) instantiating a transactional object on a client directly corresponding to a service request;

(b) instantiating one or more business-related objects on said client;

(c) said client associating said business objects with a said service object;

(d) transporting said service and associated business objects to a server; and

(e) said server executing said service object.

In a further aspect the invention provides a method for performing a client-server transaction, comprising the steps of:

(a) defining a series of transactional objects on a client, each object directly corresponding to a service request;

(b) defining a series of business-related objects on said server;

(c) in response to a service request, instantiating a service object on said client from among said series of service objects;

(d) instantiating one more business objects on said client;

(e) associating said one or more business objects with said service object on said client;

(f) transporting said service and associated business objects to a server;

(g) executing said service object by said server;

(h) modifying said business objects or instantiating new business objects by said server in response to said execution; and

(i) returning said service object and said modified or new business objects to said client.

In a further aspect the invention provides a method for performing a client-server transaction, comprising the steps of:

(a) instantiating a transactional object on the client that directly corresponds to a service request;

(b) transporting said object to a server; and

(c) executing said service on said server.

In a further aspect the invention provides a client-server process, comprising:

(a) a client process including:

(i) an application layer in which exists a series of transactional objects directly corresponding to a service request, and a series of business-related objects, and wherein, in response to a service request, one of said service objects is instantiated and associated with one or more instantiated said business objects; and

(ii) a middleware layer in which said service and associated business objects are converted into a binary stream; and

(b) a server process including:

(i) a middleware layer, receiving said binary stream and recovering said service and business objects; and

(ii) an application layer executing said recovered service object.

In a yet further aspect the invention provides a client-server computing system, comprising:

(a) a plurality of client computers each having processor means implementing an application layer, and means implementing a middleware layer linked with a respective application layer;

(b) a plurality of server computers, each having processor means implementing an application layer, and means implementing a respective middleware layer; and

(c) a communications link interconnecting said client machines and said server machines such that service requests and corresponding replies can be sent between a client machine and a server machines; and

wherein, in response to a service request on a client machine, said client application layer instantiates a transactional object corresponding to said service request and instantiates one or more business-related objects, associates said service object with said one or more business objects, and passes said associated object to said client middleware layer, said client middleware layer passing a binary form of said associated objects to said server middleware layer via said communications link, and further wherein, said server middleware layer reinstantiates said associated objects and passes them to said server application layer for said service object to be executed, the result of said execution causing said business objects to be modified or reinstantiated, and said service object associated with said modified or new business objects being returned to said client application layer via said server middleware layer and said client middleware layer.

The invention further offers an object oriented programing construct of a transactional object directly corresponding to a service request associated with one or more business-related objects.

The associated business objects can be filtered to pass only selected attributes or behaviours. Further, translation logic can be defined for translating executing business objects to a database form. The database is accessed by the database form of the objects to conduct an enquiry. The service and associated business objects are converted to a binary stream on the client and recovered on the server. The client and server can include storage means, storing the series of service and business object definitions, and, on the server, database translational logic.

In a further aspect the invention provides a method for performing a computer process, comprising the steps of:

(a) instantiating a transactional object directly corresponding to a service request;

(b) instantiating one or more business-related objects;

(c) associating said business objects with a said service object;

(d) transporting said service and associated business objects to another computer system.

In a further aspect the invention provides a computer-readable medium having a plurality of sequences of instructions stored thereon including sequences of instructions which, when executed by one or more processors, cause said one or more processors to perform the steps of;

(a) instantiating a transactional object on a client directly corresponding to a service request;

(b) instantiating one or more business-related objects on said client;

(c) said client associating said business objects with a said service object;

(d) transporting said service and associated business objects to a server; and

(e) said server executing said service object.

### BRIEF DESCRIPTION OF THE DRAWINGS

Embodiments of the invention will now be described with reference to the accompanying drawings, in which:

FIG. 1 shows the topology of a distributed computing system;

FIG. 2 is a generalised architecture diagram;

FIG. 3 shows the client-server software architecture of FIG. 2 in more detail;

FIG. 4 shows an object model for a Business Object;

FIG. 5 is a flow diagram showing build-time processes;

FIG. 6 is an object model for Filter Objects;

FIG. 7 is an object model for a Translation (DB) Objects;

FIG. 8 is a flow diagram showing events that occur on a client when a service is created and executed;

FIG. 9 is a flow diagram showing events that occur on a server when a service is created and executed; and

FIG. 10 is a flow diagram showing events that occur on a client when a response is received from a server.

### DESCRIPTION OF PREFERRED EMBODIMENTS AND BEST MODE

Representative Application Environment

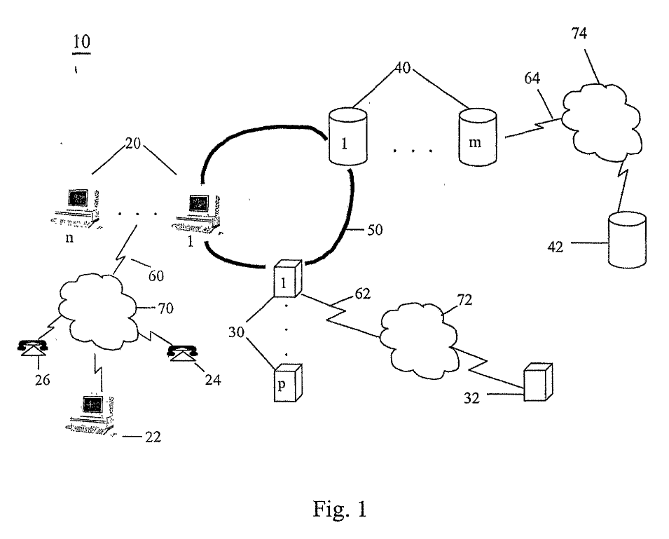

FIG. 1 is a representative topology of a three tier computing system 10 upon which the invention can be implemented. The presentation (or client/user) tier is represented by a number (1 . . . n) of workstations 20, that can be appropriate computing terminals, for example personal computers. The business tier is represented by a number (1 . . . p) of servers 30, that can be dedicated mini or mainframe computers. The data tier is represented by a number (1 . . . m) of databases 40, which can include dynamically managed magnetic or optical storage media.

The computing system 10 is of an ‘open’ design, providing communication links 60,62,64, via external networks 70,72,74 to like-devices 22,32,42 and remote telephone terminals 24, 26.

The workstations 20, servers 30, and databases 40 are interconnected by a Local or Wide Area Network (LAN or WAN) 50. The LAN/WAN 50 carries information passing between each of the three basic elements described. It will be appreciated that the topology shown in FIG. 1 is representative only, and that any other convenient form of network could be implemented such that the objective of information passing between the workstations 20, servers 30, and databases 40 is achieved.

For the purposes of a non-limiting illustration, consider the system 10 of FIG. 1 being used by a Telco operating across many States of the United States. Such a Telco will typically support local, regional, interstate and international voice and data calls, as well as cellular mobile voice and data traffic. Customers of the Telco can choose from a wide range of goods and services including, for example, the installation of second phone/fax/lnternet lines, call forwarding, and messaging. They also will expect to be able to make enquiries of CSRs stationed at the workstations 20 concerning billing and service faults. It is not unreasonable to expect a modem-day Telco to have at least 1 million customers, typically requiring at least 500 CSRs. A Telco system infrastructure of this size can expect to handle about 15,000 business transactions per hour. For each business transaction there may be 6 CSR machine transactions required, and each individual machine transaction can involve up to 20 database transactions (i.e. I/Os).

To give a better example of the size of computing hardware required to achieve such performance, it is considered that the CSR workstations 20 should be Pentium™ personal computers running the Windows NT™ operating system, the servers 30 can be one or more IBM UNIXT™-based 12-way RS6000™ S-70 machines, and the databases would require a capacity of about 40 Gbytes, managed by an Oracle ™ or IBM DB-2™ system. There would, of course, be other operational LAN/WAN servers required to handle data communications, as would be readily understood by a person skilled in the art.

In business systems such as a Telco, customers call CSRs and request goods or services in everyday language, such as a request for ‘call waiting’ to be activated on a domestic telephone line. Indeed, the CSR also operates at this level and is presented with information (as a GUI) on the display of the workstation relating to such goods and services. The computing system 10 then acts on customers ordered goods or services or inquiries.

Overview

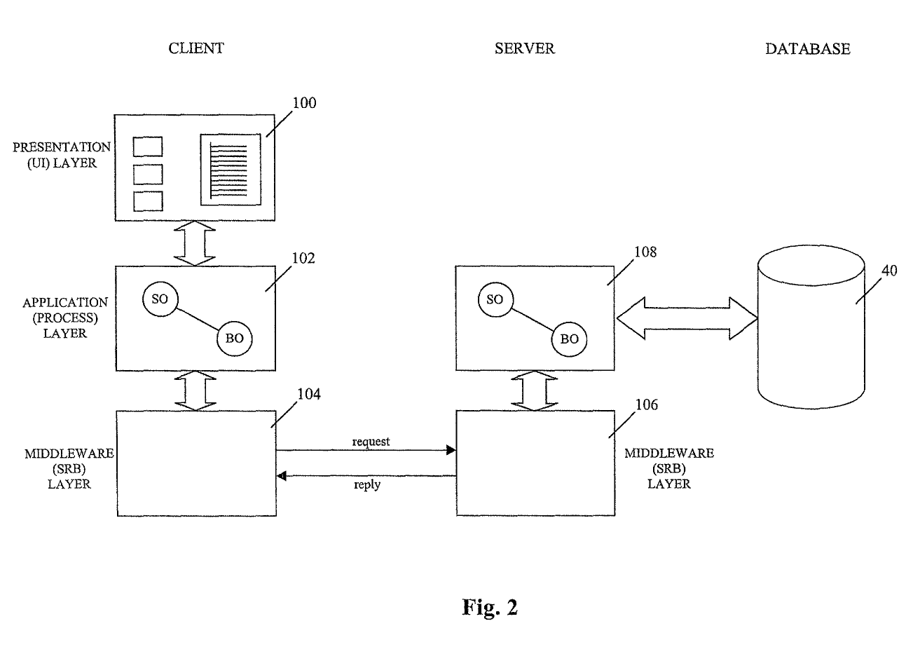

FIG. 2 shows a reduced representation of the client-server system of FIG. 1, in the form of a single ‘client process’, ‘server process’, and database. As mentioned above, the processes can reside on a respective client workstation 20 and server machine 30, or on a single server machine 30. Another configuration could be the browser of a personal computer acting as the client and a web application server acting as the server. That same web application server could act, at the same time, as a client of a server mainframe machine.

On the client, the presentation (UI) layer 100 presents a user with a graphical user interface. In the Telco illustration mentioned above, a CSR could implement business-level transactions via the UI, such as ‘Find Customer’, which seeks to extract a customer's details. The application (process) layer 102 is where a CSR's inquiries or orders are translated into ‘service requests’. The middleware (SRB) layer 104 deals with the framing and dispatching of service requests as bit streams.

On the server, a similar, but not identical middleware (SRB) layer 106 receives bit streams and recreates service requests therefrom. The server SRB 106 communicates with the server application (process) layer 108 where the recreated service requests are executed. The application layer 108 has communication with a batabase 40 to persist or retrieve data stored therein relating to any service requests.

In response to a service request on the client, the methodology at run-time involves:

1. Instantiation of one or more Business Objects (BOs) on the client

2. Populating the BO with any needed attributes

3. Instantiating a Service Object (SO) on the client

4. Populating (i.e. associating) the SO with one or more BO(s)

5. Requesting the SO to be executed

6. Passing the populated SO to the server as a binary stream

7. Reinstantiating the SO and associated BO(s) on the server

8. Executing the service on the server

9. Populating the SO with the results of the executed service

10. Passing the result SO back to the client

11. Updating the BO attributes

What is to be noted is that execution of the service occurs only on the server. Also, no record of the Business or Service Object is kept on either the client or the server— the BOs an SOs exist only for the duration of the service execution.

The idea of a Service Object—which equates to the action required to be performed on the (one or more) Business Objects—is key. Compared with the prior art, the Service Objects represent a further class of object. The thrust of the present invention is mainly on the action to be performed, captured by the SOs that execute on the server. The number of calls that must be made between client and server is reduced, and the need for copies of objects to be stored on both client and server is obviated.

Specific Implementation

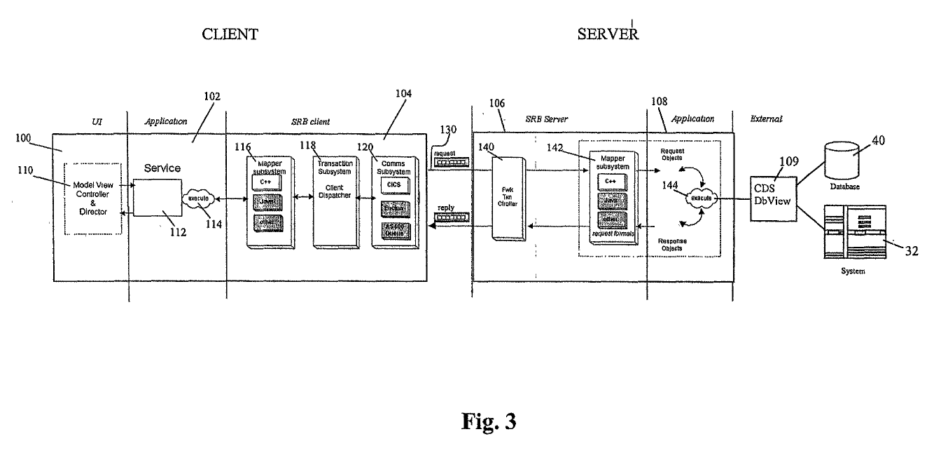

A fuller description of the invention will now be given with reference to FIGS. 3 to 10.

FIG. 3 is a software architecture, similar to FIG. 2, but showing the respective layers in greater detail. The client has the elements of a User Interface 100, an application layer 102, and a Service Request Broker 104. The server 30 has a similar (but not identical) SRB layer 106, and an application layer 108. The application layer 108 links to a Common Data Services system 109, controlling access to an external database 40 (or an external server system 32).

A Controller and Director subsystem 110 resides within the UI 100, and passes and receives data to a service subsystem 112 that includes a linked ‘execute’ operation 114. Service Objects to be executed are passed to a Mapper subsystem 116, that can be constituted by code written in C++, Java, or any other suitable programing language. The Mapper subsystem 116 is linked to a Transaction subsystem 118, which has a dispatching function. The Transaction subsystem maps SOs to destination servers. A Communications subsystem 120 packages objects into (or from) binary data streams. This can be achieved by middleware such as the CICS, Encina, or AS 400 Queue products of International Business Machines Corporation. Other possibilities include MQ, HTTP, TCP/IP sockets, CORBA, and Java RMI. A two-way network link 130 passes binary data between the client and the server (i.e. request and reply).

On the server, binary data is handled by a Transaction Controller 140. In turn, the Transaction Controller 140 passes reinstantiated objects to a matching Mapper subsystem 142. The application layer 108 provides an execute function 144 on each 50 and the associated BOs.

The SOs and BOs that are utilized by the client and server are defined in a ‘Build-time’ (as will be described).

Business Objects

Taking the Telco example, a Business Object relates to the ‘business world’ functionality performed by the computing system 10—in this embodiment a customer care and billing service. Specific examples of BOs are “Customer”, “Account”, and “Statement”. BOs thus can be thought of as the building blocks or actors of the Telco customer care and billing business. They are ‘data’, or things of interest in a business sense.

Service Objects

A Service Object captures a transactional property of the one or more BOs with which it is associated. In other words, a SO acts upon one or more BOs to catpure their intended interaction. SOs perform actions against BOs. They usually represent a business transaction An example of a Service Object would be ‘Find Customer’. A FindCustomer SO could result in the interaction with a ‘Customer’ BO and an ‘Address’ BO. On the other hand, the service request could be to find a customer whose name starts with a given letter, meaning that there is only an interaction with the ‘Customer’ BO.

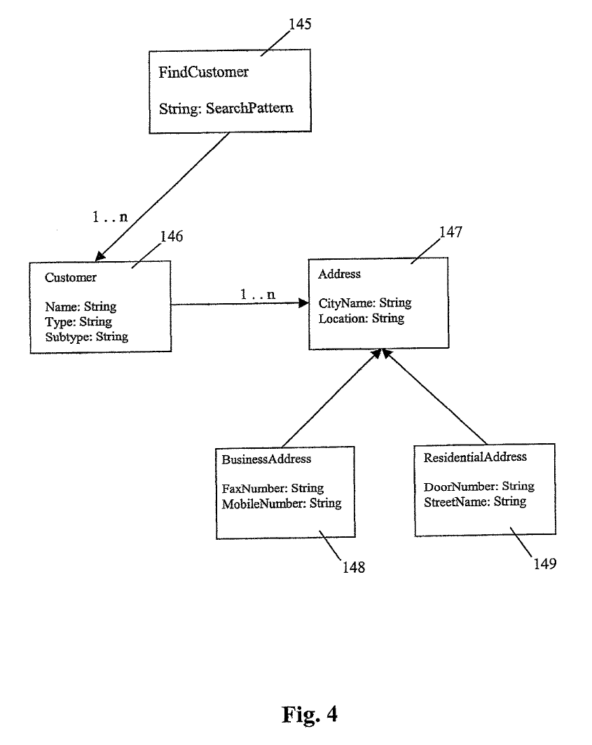

FIG. 4 shows an object diagram for the FindCustomer SO 145, which has the attribute ‘SearchPattern’. The SO 145 has a 1-to-n association with the BO ‘Customer’ 146. By ‘association’, is meant that the BO constitutes the parameter or arguments for the SO. The ‘Customer’ Object 146 has the attributes ‘Name’, ‘Type’, and ‘Subtype’. It, in turn, has a 1-to-n association with a BO ‘Address’ 147. This association is navicable in both directions. The ‘Address’ Object 147 has the attributes ‘CityName’ and ‘Location’. Additionally, ‘Address’ has inheritances from the sub-classes ‘BusinessAddess’ 148 and ‘ResidentialAddress’149. They have the respective attributes of ‘FaxNumber’ and ‘MobileNumber’, and ‘DoorNumber’ and ‘StreetName’.

Build-Time

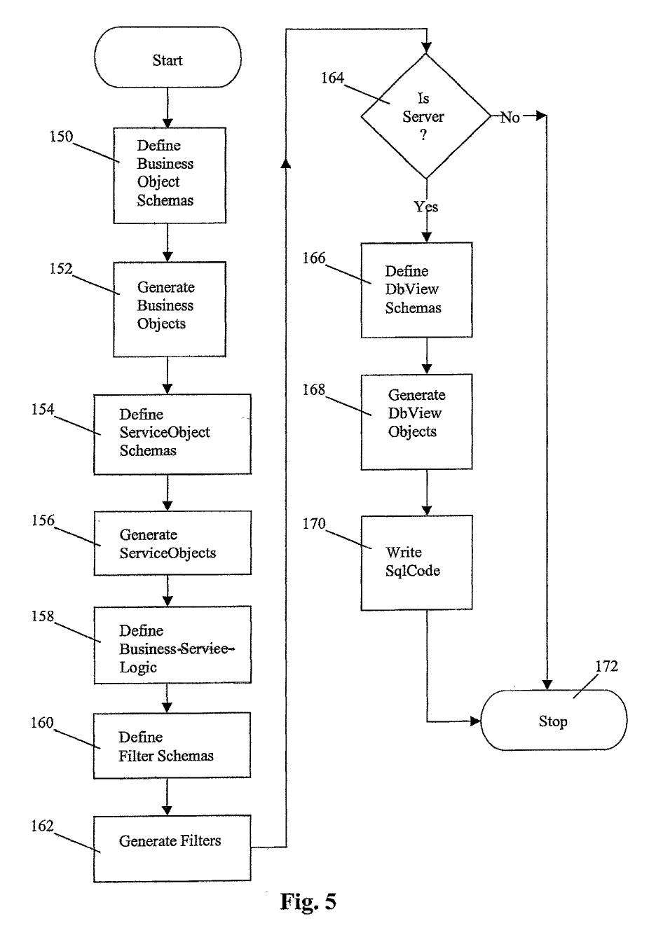

FIG. 5 shows the steps performed during ‘build-time’, by which three “schema” are utilized. These are the definition of: (i) Business and Service Objects (existing in the client and server application layers 102, 108), (ii) mapper filters (existing in the mapper subsytem 116), and (iii) database access ‘objects-to-relational database’ translation (existing in the Common Data Services system 109). These schema definitions are achieved by use of the Object Definition Language (ODL).

The ODL performs the interface between the object world and the physical layer world. It captures the complete state descriptions of objects and also their partial states (i.e. through the use of the Filters), and also object translations (i.e. Translators). The schema language supports complex inheritance patterns and relationships of BOs and SOs. The ODL enables all objects to be represented externally in a common language. This enables applications written in different languages to use the same objects.

The first two schema definitions are relevant to both client and server, however, the third schema applies to only the server.

(i) Object Schemas

The schema definition for the ‘Customer’ Object 146 hierarchy shown in FIG. 4, step 150, is:

object Customer {

String Name, Type, Subtype;
many_relation Address [Address];

};

The relationship with the Address Object 147 is specified by the many_relation syntax. The “[Address]” is the name of the association. The remaining Objects 147-149 are defined by the following syntax:

object Address{

String CityName, Location;

};
object BusinessAddress inherits Address {

String FaxNumber, POBoxNumber;

};
object ResidentialAddress inherits Address {

String DoorNumber, StreetName;

};

These syntactical definitions are applied to a suitable schema compiler in step 152, to establish the Business Objects definitions. The compiler converts the syntax into a high level code, such as C++or Java.

Next, in step 154, the Service Object schemas are defined. The specific embodiment is ‘FindCustomer’ 145.

object FindCustomer{
String SearchPattern;
many_relation Customer [resultSet];
};

The syntax defines the Service Object for the business service listing all Customers whose names match the given Search Pattern. The syntax could equally be written in XML.

This definition is applied to the schema compiler, in step 156, to generate code in a high level language such as C++ or Java to establish Service Object definitions.

In step 158, the appropriate ‘business logic’ is defined. This represents the behaviour exhibited by each Business Object. For the Customer 14, an example of such behaviour is the logic to identify all credit accounts of a given customer that are overdue. For an Account BO, the business logic might identify all statements attached to an account.

Business logic attributes of BOs can impact on the execution of a SO. For example, some SOs rely directly on the behaviour of an associated BO: The service of identifying over-due credit accounts for a given customer requires the SO to directly utilize the Customer BO business logic. A service request can interact with two or more BOs. The service of identifying over-due -accounts for a given customer and the production of statements for the last three months on each account requires the SO to interact with the business logic of the Customer and Account BOs.

(ii) Filter Schemas

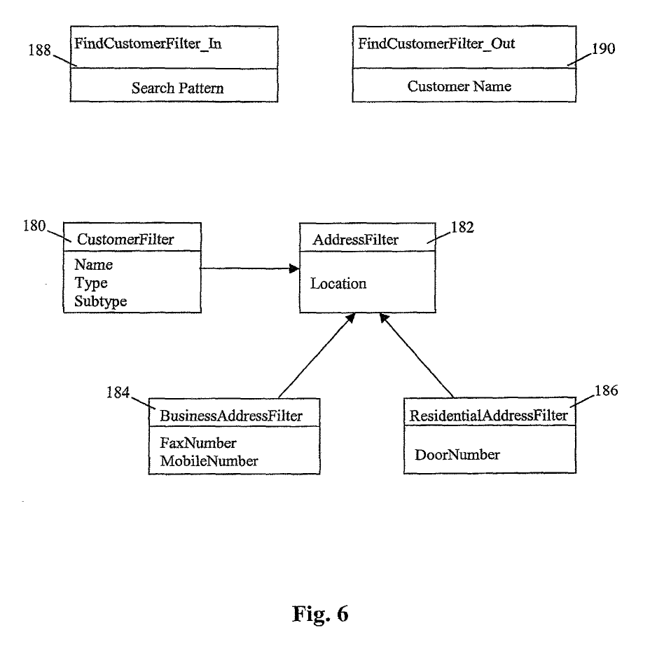

In step 160, Filter Schemas are defined. FIG. 6 shows an object diagram relating to the above-noted syntax. The CustomerFilter 182 has the attributes ‘Name’, ‘Type’, and ‘Subtype’. It has association with ‘AddressFilter’ 182, which has the single attribute ‘Location’. AddressFilter 182 inherits the filter objects BusinessAddressFilter 184 and ResidentialAddressFilter 186. BusinessAddressFilter has the attributes ‘FaxNumbers’ and ‘MobileNumber’. On the other hand, ResidentialAddressFilter 186, has only the attribute DoorNumber.

For the Address Object 147, the AddressFilter Object syntax is as follows:

filter AddressFilter filters Address {

Location;

};

A Filter refines an object, meaning that the filter lets only the attributes specified in the definition to pass through to an external stream (which could be a file or a network). In the above definition, ‘AddressFilter’ allows only the Location attribute from the Address to pass through.

For the BusinessAddress and ResidentialAddress Filter Objects, the syntax is:

filter BusinessAddressFilter inherits AddressFilter
filters BusinessAddress {

FaxNumber, MobileNumber;

};
filter ResidentialAddressFilter inherits AddressFilter
filters ResidentialAddress {

DoorNumber;

};

A Filter can inherit from other filters. The filter hierarchy should be strictly consistent with the object hierarchy. In the above example (FIG. 4), BusinessAddress 148 inherits from Address 147, and, in FIG. 6, so does BusinessAddressFilter 184 from AddressFilter 182. By inheriting from AddressFilter, BusinessAddressFilter acquires all the properites of AddressFilter. This means that BusinessAddressFilter allows FaxNumber, MobileNumber and also the Location (acquired from AddressFilter) attributes to pass through to the stream. The same applies for the ResidentialAddressFilter Object 186.

The syntax for the CustomerFilter Object 180 is:

filter CustomerFilter filters Customer {

Name, Type, Subtype;
AddressFilter filters Address {

select BusinessAddressFilter when BusinessAddress;
select ResidentialAddressFilter when ResidentialAddress;

select default when unknown; // catch all.

}

};

At the SO level, the FindCustomerFilter_In Object 188 is defined as:

filter FindCustomerFilter_In filters FindCustomer{

SearchPattern;

}

This syntax defines a Filter for FindCustomer which would be used when the Service Object is sent from the client to the server. It will only allow the ‘SearchPattern’ to pass through to the server.

filter FindCustomerFilter_Out filters FindCustomer{

association resultset {

Name;

}

This syntax defines a filter which would be used when the SO is sent to the client from the server. It would send back only the CustomerName attribute for the selected list of customers.

A Filter can use other filters. This is similar to a relationship between them. In the above example, we can see that CustomerFilter (that filters the Customer object) makes use of AddressFilter to filter the Address relationship defined in the Customer object. It also refines the selection capability if the relationship can contain instances of different types. For example, of a customer has both a residential address and a business address then both types of objects may be found in the relationship. The syntax specifies what filter has to be used and when. If the type of an object in the relationship is unknown, then a select-default-when-unknown clause is used to default to externalize all the attributes in the unknown object.

In step 162 of FIG. 5, a schema compiler generates the set of Filters based on the syntax models noted above. The syntax could equally be written in XSL.

(iii) Translation Schemas

The steps in FIG. 5 described up to this point occur for both client and server. The definition of the BOs and SOs occurs in the respective Application layers 102, 108, and the definition of the Filters occurs in the respective mapper subsystems 116, 142.

On the server-side, a translational interface with the relational database is provided by the Common Data Services (Db Views) system 109. The CDS system 109 has the knowledge necessary to act upon the executing reinstantiated Business Object to persist, retrieve and lock data. This means that neither the client nor the server (and the SOs and BOs) need to carry information relating to actual database activities. This is advantageous because different forms of database can be transparently accommodated (e.g. DB2 replaced by Oracle).

Referring again to FIG. 5, step 164 in the build-time sequence limits the succeeding steps only to servers (i.e. the CDS system 109 translation function). In step 166, the DbView schemas are defined to translate from Business Objects into a relational representation. A schema compiler then operates in step 168 to generate DbView objects. Finally, SqlCode is written in step 170 that facilitates DB access.

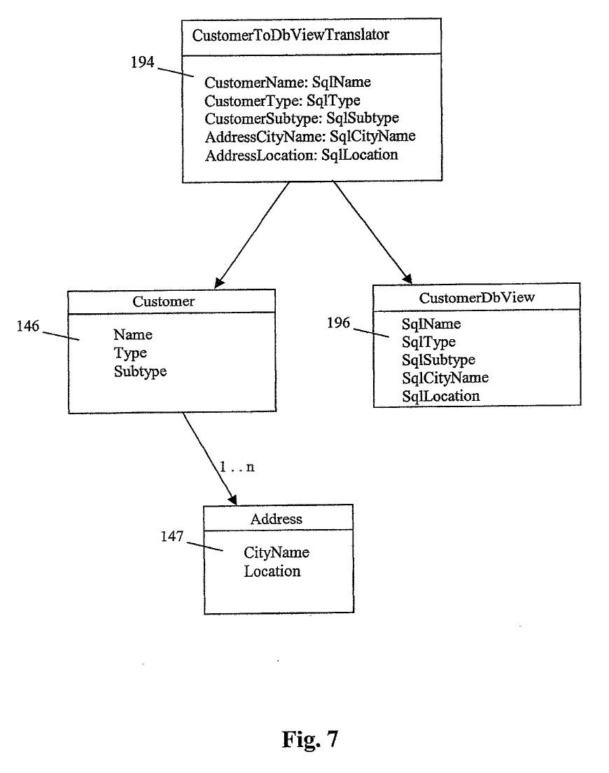

FIG. 7 shows an object model for the DB translation. The reinstantiated Customer Object 146 (having the same one-to-n associations with Address Objects 147), is associated with a CustomerToDbViewTranslator Object 194. The Translator Object 194 has attributes ‘CustomerName’, ‘CustomerType’, ‘CustomerSubtype’, ‘AddressCityName’, and ‘AddressLocation’. These attributes are of the respective type as shown in FIG. 7. The Translator Object 194 also has an association with a CustomerDbView Object 196. This object carries the Sql knowledge with it relating to the attribute types in the Translator Object 194.

The syntax for the Translator Object 194 is:

translation CustomerToDbViewTranslator {

Customer: CustomerDbView

CustomerName: SqlName,
CustomerType: SqlType,
CustomerSubtype: SqlSubtype

association

Address : CustomerDbView

CityName:SqlCityName,
Location:SqlLocation

};

The syntax for the CustomerDBView Object 196 is:

object CustomerDbView {

StringSqlName, SqlType, SqlSubtype, SqlCityName,
SqlLocation;

}

A translation is a specification for mapping from one object to another. In the above example, the Customer Object 146 and its address relationship is mapped into the CustomerDbView Object 196. This construct abstracts the transformation from object domain to a relational domain, and also provides a uniform object interface.

Execution of a Service

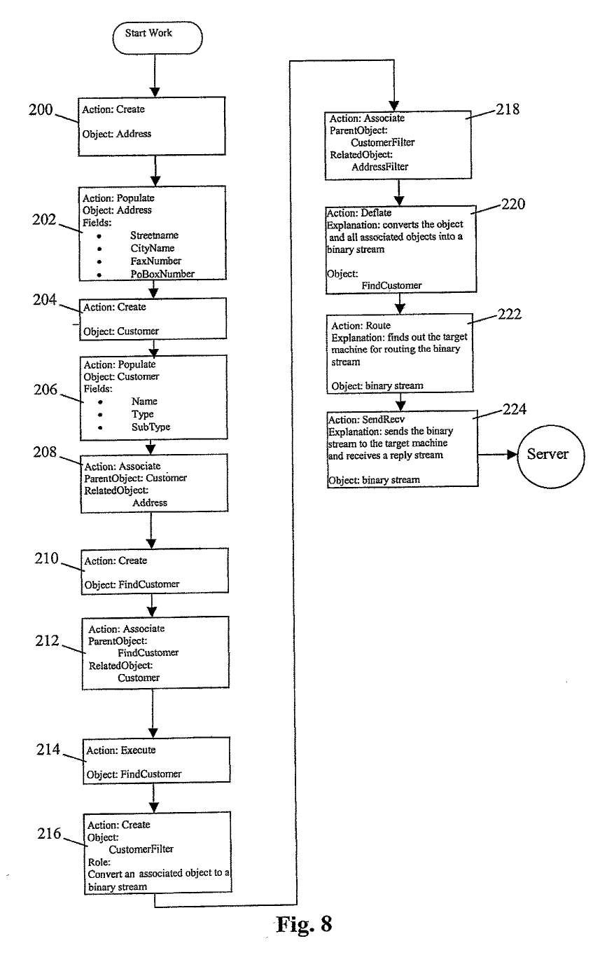

FIG. 8 shows the steps performed on a server in response to a run-time service request, being ‘FindCustomer’. In step 200, the BusinessAddress Object 148 is instantiated. This Object is then populated, in step 202, with the fields previously described in FIG. 4. Similar steps (not shown) are performed for the ResidentialAddress Object 149. The Customer Object 146 is now instantiated and is populated with the fields: Name, Type and Subtype in steps 204 and 206. The Customer Object is then associated with the related BusinessAddress Object in step 208. In step 210, the FindCustomer SO 145 is instantiated. This forms a Service Object (termed ‘Parent’) in step 212. In step 214, the FindCustomer Object is executed by making a call upon itself All of these steps are performed in the service subsystem 112.

A Filter Object ‘CustomerFilter’ is instantiated, which acts to convert a Service Object into a binary stream, in step 216. In step 218, the Service (Parent) Object and Related Business Object, are associated. The CustomerFilter Object is then deflated in step 220 to convert the Service Object and all associated Business Objects into a binary stream. Steps 216-220 are performed in the mapper subsystem 116.

The binary stream is then routed to the target server in step 222 (by the transaction subsystem 118). Finally, in step 224, the binary stream is sent by the comms subsystem 120 to the target server.

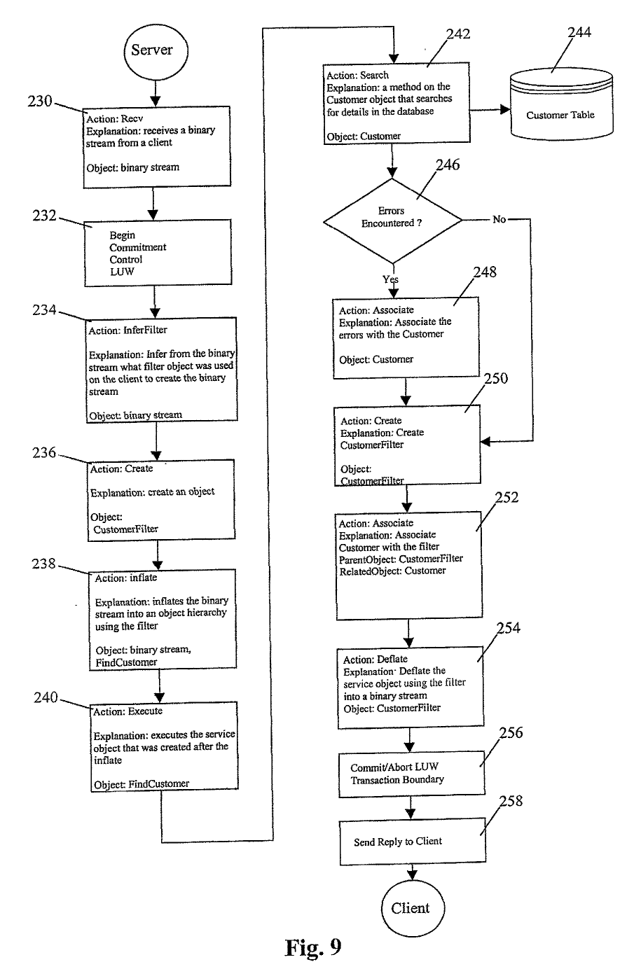

Turning now to FIG. 9, the steps performed on the server are described. The binary stream from the client is received in step 230. The Logical Unit of Work (LUW) commitment is then controlled by the Transaction Controller 140 (step 232). In step 234, a filter infers from the binary stream what Filter Object was used on the client to create the binary stream. The CustomerFilter Object 180 is selected. Using this filter, step 238 inflates/reinstantiates the binary stream into an object hierarchy, to recover the Service Object. In step 240, the CustomerObject is executed Steps 234 through 238 are performed in the mapper subsystem 142, while step 240 is performed in the Application layer 108 by the execute function 144.

In this case, the required execution action was “search” in which case the Customer Object is stored, in step 242, into a Customer Table 244. This transaction is handled by the CDC DbView system 109, in accordance with the translation schema described above.

There then follows a test, in the application layer 108, as to whether any errors were encountered (step 246. If “Yes”, details of the errors are associated with the FindCustomerObject in step 248. Following on, in step 250, a new CustomerFilter Object is created (step 250), and an association of it performed with the existing Customer Object The same Service Object originally instantiated on the client is utilised on the server to return to service result The associated Business Objects will be a modified form of the original BO or a newly instantiate BO, depending upon the result of the database access. In step 254, the Service Object is deflated using the Filter into a binary stream. All of steps 248 through 254 are performed in the mapper subsystem 142.

The transaction subsystem 140 then performs the work, in steps 256 and 258, of commiting or aborting the Logical Unit of Work's transaction boundary, and sending the binary stream to the target client.

No record of the Service Object and associated Service Object(s) are kept on the server after commitment has occurred.

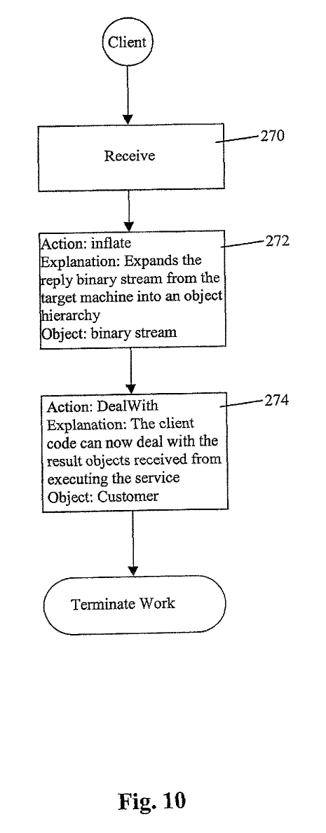

FIG. 10 shows the steps performed at the client when a binary stream is returned. It is firstly received by the comms subsystem 120 (step 270). In step 272, the reply binary stream is inflated by the mapper subsystem 116 into an object hierarchy. In step 274, the application layer 102 deals with the result CustomerObject. Again, no record of the Service Object and associated Business Object(s) are kept on the client.

Advantages

For the present invention, interaction between the client and server occurs in a way that proves to be highly scalable from the server point of view. Objects exist on the server for the brief duration of transactions. Instead of millions of Objects, that require memory and other computing resources to support thousands of clients, the number of Objects existing on the server at one point of time is reduced by thousand folds, the Objects also exist only for the duration of the transaction. The invention further enhances scalability in that there is no sharing of BOs on the server by different clients, rather this is done only at database level.

The use of filters in the Mapper subsystem significantly reduces the amount of data sent across the network, and thus also enhances the overall scalability and performance of the computing applications that are supported. For example, to update a customer address, the customer unique id and the address object are required. However, the Customer Objects may have many other attributes (name, age, sex, social security number, etc) and many other associated Objects (accounts, history, loans, etc). For each type of transaction, which Objects and what attributes of these Objects are required to be transmitted is specified in a manner to create efficiencies. There also is an overall reduction in the number of remote calls by having the SO and BO(s) ‘package’ passed-by-value.

Location transparency and load balancing is also a feature of the invention, since a client does not need to know where a service request is being executed, meaning that the target server can be chosen to suit load demands and availability.

The externalization of a Service Object (and its associated Objects), in a flattened buffered form, is achieved by asynchronous messaging. This allows optimisation of server utilisation.

The invention also offers the important advantage that service requests between client and server can be handled synchronously or asynchronously.

The invention also is independent of the transport layer implementation, giving it great flexibility across a number of computing platforms and architectures.

Numerous alterations and modifications, as would be apparent to one skilled in the art, can be made without departing from the basic inventive concept. All such modifications and alterations are to be considered as incorporated herein.

We claim:

1. A method for performing a transaction between computer systems, comprising the steps of:
(a) instantiating a transactional object on the first computer system directly corresponding to a service request;
(b) instantiating one or more business-related objects on said first computer system;
(c) said first computer system associating said business objects with a said service object;
(d) transporting said service and associated business objects to the second computer system; and
(e) said second computer system executing said service object.

2. The method of claim 1, comprising the further steps, following step (e) of:
(f) modifying said business objects or instantiating new business objects by said second computer system in response to said execution; and
(g) returning said service object and said modified or new business objects to said first computer system.

3. The method of claim 2, comprising the further step, following step (c), of:
(h) filtering said associated business objects to pass only selected attributes or behaviours.

4. The method of claim 3, comprising the further steps, occurring before step (a), and performed by both said first and said second computer system, of:
(i) defining a series of said service objects; and
(j) defining a series of business-related objects.

5. The method of claim 4, comprising the further steps, performed on said second computer system, of:
(k) defining translation logic for translating executing business objects to a database form; and
(l) accessing a database with said database form objects to conduct an enquiry.

6. The method of claim 5, whereby step (d) includes the steps of:
(di) converting said service and associated business objects to a binary stream by said first computer system;
(dii) passing said binary stream to said second computer system; and
(diii) reinstantiating said binary stream to recover said service and associated business objects.

7. A method for performing a client-server transaction, comprising the steps of:
(a) defining a series of transactional objects on a client, each object directly corresponding to a service request;
(b) defining a series of business-related objects on said server;
(c) in response to a service request, instantiating a service object on said client from among said series of service objects;
(d) instantiating one more business objects on said client;
(e) associating said one or more business objects with said service object on said client;
(f) transporting said service and associated business objects to a server;
(g) executing said service object by said server;
(h) modifying said business objects or instantiating new business objects by said server in response to said execution; and
(i) returning said service object and said modified or new business objects to said client.

8. The method of claim 7, comprising the further step, following step (e), of:
(j) filtering said associated business objects to pass only selected attributes or behaviours.

9. The method of claim 8, comprising the further steps, performed on said server, of:
(k) defining translation logic for translating executing business objects to a database form; and
(l) accessing a database with said database form objects to conduct an enquiry.

10. The method of claim 9, whereby step (f) includes the steps of:
(fi) converting said service and associated business objects to a binary stream by said client;
(fii) passing said binary stream to said server; and
(fiii) reinstantiating said binary stream to recover said service and associated business objects.

11. A method for performing a client-server transaction, comprising the steps of:
(a) instantiating a transactional object on the client that directly corresponds to a service request;
(b) transporting said object to a server; and
(c) executing said service on said server.

12. A client-server process comprising:
(a) a client process including:
(i) an application layer in which exists a series of transactional objects directly corresponding to a service request, and a series of business-related objects, and wherein, in response to a service request, one of said service objects is instantiated and associated with one or more instantiated said business objects; and
(ii) a middleware layer in which said service and associated business objects are converted into a binary stream; and
(b) a server process including:
(i) a middleware layer, receiving said binary stream and recovering said service and business objects; and
(ii) an application layer executing said recovered service object.

13. The client-server process of claim 12, further wherein said server application layer modifies said business objects or instantiates new business objects depending upon the result of said service execution, and returns said service object and associated business objects to said server middleware layer which, in turn, passes said result to said client middleware layer.

14. The client-server process of claim 13, further comprising:
on said client and said server processes:
(iii) object schemas contained in the respective application layer, by which said sets of service objects and business objects are defined.

15. The client-serves process of claim 14, further comprising:
on said client and said server processes:
(iv) filter schemas, contained within the respective middleware layers, which filter instantiated business objects to pass a subset of attributes.

16. The client-server process of claim 15, further comprising:
on said server process:
(v) translation schemas translating objects to database form.

17. A client-server computing system, comprising:
(a) a plurality of client computers each having processor means implementing an application layer, and means implementing a middleware layer linked with a respective application layer;
(b) a plurality of server computers, each having processor means implementing an application layer, and means implementing a respective middleware layer; and
(c) a communications link interconnecting said client machines and said server machines such that service requests and corresponding replies can be sent between a client machine and a server machines; and
wherein, in response to a service request on a client machine, said client application layer instantiates a transactional object corresponding to said service request and instantiates one or more business-related objects, associates said service object with said one or more business objects, and passes said associated object to said client middleware layer, said client middleware layer passing a binary form of said associated objects to said server middleware layer via said communications link, and further wherein, said server middleware layer reinstantiates said associated objects and passes them to said server application layer for said service object to be executed, the result of said execution causing said business objects to be modified or reinstantiated, and said service object associated with said modified or new business objects being returned to said client application layer via said server middleware layer and said client middleware layer.

18. The system of claim 17, further comprising:
(d) one or more databases accessible by said server machines via their respective application layer in response to execution of a service object to return said result.

19. The system of claim 18, further comprising:
(e) storage means, on said client and said server machines, for storing a series of service object definitions and a series of business object definitions.

20. The system of claim 19, further comprising:
(f) a set of filters definitions, stored in said storage means, that are accessed by the client middleware to pass only desired attributes of business objects.

21. The system of claim 20, further comprising:
(g) of translational logic, stored in said storage means of said server machines, for translating executing services to database form that can access said database.

22. An object oriented programing construct comprising a transactional object directly corresponding to a service request associated with one or more business- related objects.

23. A method for performing a computer process, comprising the steps of:
(a) instantiating a transactional object directly corresponding to a service request;
(b) instantiating one or more business-related objects;
(c) associating said business objects with a said service object;
(d) transporting said service and associated business objects to another computer system.

24. The method of claim 23, comprising the further step, following step (c), of:
(e) filtering said associated business objects to pass only selected attributes or behaviours.

25. A computer-readable medium having a plurality of sequences of instructions stored thereon including sequences of instructions which, when executed by one or more processors, cause said one or more processors to perform the steps of:
(a) instantiating a transactional object on a client directly corresponding to a service request;
(b) instantiating one or more business-related objects on said client;
(c) said client associating said business objects with a said service object;
(d) transporting said service and associated business objects to a server; and
(e) said server executing said service object.

26. A computer-readable medium having a plurality of sequences of instructions stored thereon including sequences of instructions which, when executed by one or more processors, cause said one or more processors to perform the steps of:
(a) defining a series of transactional objects on a client, each object directly corresponding to a service request;
(b) defining a series of business-related objects on said server;
(c) in response to a service request, instantiating a service object on said client from among said series of service objects;
(d) instantiating one more business objects on said client;
(e) associating said one or more business objects with said service object on said client;
(f) transporting said service and associated business objects to a server,
(g) executing said service object by said server,
(h) modifying said business objects or instantiating new business objects by said server in response to said execution; and
(i) returning said service object and said modified or new business objects to said client.

27. A computer-readable medium having a plurality of sequences of instructions stored thereon including sequences of instructions which, when executed by one or more processors, cause said one or more processors to perform the steps of-
(a) instantiating a transactional object directly corresponding to a service request;
(b) instantiating one or more business-related objects;
(c) associating said business objects with a said service object;
(d) transporting said service and associated business objects to another computer system.

28. A computer-readable medium of claim 27 comprising the further step, following step (c), of:
(e) filtering said associated business objects to pass only selected attributes or behaviours.

29. A computing system for performing a transaction between computer systems, comprising:
the first computer system instantiating a transactional object directly corresponding to a service request, instantiating one or more business-related objects on said first computer system, said first computer system associating said business objects with a said service object and transporting said service and associated business objects; and
the second computer system receiving said service and associated business objects and executing said service object.

30. The system of claim 29, wherein said second computer system, furthermore, modifies said business objects or instantiates new business objects in response to said execution and returns said service object and said modified or new business objects to said first computer system.

31. The system of claim 29, wherein said first computer system, furthermore, filters said associated business objects to pass only selected attributes or behaviours.

32. A computer system for performing the steps of:
(a) instantiating a transactional object directly corresponding to a service request;
(b) instantiating one or more business-related objects;
(c) associating said business objects with a said service object;
(d) transporting said service and associated business objects to another computer system.

33. The system of claim 32, performing the further step of; filtering said associated business objects to pass only selected attributes or behaviours.
